(19) United States
(12) Patent Application Publication
(10) Pub. No.: US 2010/0250439 A1
(43) Pub. Date: Sep. 30, 2010

(54) APPARATUS AND METHOD FOR PROTECTING CONTENTS STREAMED THROUGH RE-TRANSMISSION

(75) Inventors: Jee Hyun Park, Daejeon (KR); Jung Soo Lee, Daejeon (KR); Jung Hyun Kim, Daejeon (KR); Yeon Jeong Jeong, Daejeon (KR); Do-Won Nam, Daejeon (KR); Kisong Yoon, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/743,879

(22) PCT Filed: Dec. 15, 2008
(86) PCT No.: PCT/KR08/07403

§ 371 Date: May 20, 2010

(30) Foreign Application Priority Data
Dec. 17, 2007 (KR) 10-2007-0132850

(51) Int. Cl. G06F 21/24; G06Q 99/00; G06Q 50/00; G06Q 30/00; H04L 9/08

(52) U.S. Cl. 705/54; 705/27; 705/59; 380/283; 726/26

(57) ABSTRACT

An apparatus for protecting contents streamed through re-transmission, includes a content service site for servicing a content, managing end user and re-sender re-transmitting the content streamed from the content service site to another user, and issuing and managing a re-transmission license and a content license. The end user pays a charge to the content service site, receives an issued license from the content service site, and uses the content received from the re-sender through re-transmission.

### TECHNICAL FIELD

The present invention relates to an apparatus and method for protecting contents streamed through re-transmission, and more particularly, to an apparatus and method for protecting contents in which, in an environment where contents streamed, for example, in a peer-to-peer (P2P) manner by users are re-transmitted, a technical device for protecting a copyright for contents serviced through re-transmission is provided such that a load on a server is distributed and a variety of content reception methods and content purchase conditions are provided to users.

This work was supported by the IT R&D program of MIC/IITA [2007-S-017-01, Development of user-centric contents protection and distribution technology].

### BACKGROUND ART

In recent years, digitalized movies are increasing because digital information is easy to make and distribute. However, digital contents are easy to copy, modify, and distribute, and circulated via an unsafe Internet, causing key issues of security and copyright.

The issues are particularly caused in movies stored and reproduced on a personal computer (PC) of a user. To prevent movie files stored in the user PC from being illegally reproduced, a Digital Rights Management (DRM) scheme is used in which the movie files are encrypted and information for decrypting the encrypted movie files is provided to only authorized users. The DRM scheme allows only a person who has acquired a right to reproduce contents via a legal route to reproduce and view the contents because the contents are encrypted even though it is illegally downloaded.

Streaming refers to transmitting and reproducing data in real time without saving contents in a local system. Since downloading large movie contents consumes much time, it is common to service large movies through streaming, like video on demand. In the case of the video on demand, a content server provides service and a user receives the service in a one-to-one correspondence relationship. When the content server simultaneously provides the same content to several users, the server needs resources in proportion to the number of the users and uses network resources in proportion to the user number.

One streaming scheme includes a multicast transport scheme, which is a network scheme that allows a plurality of users to receive the same content in order to solve increase in network use in proportion to the number of users. That is, use of the multicast transport scheme to simultaneously provide the same content to several users can lead to considerable decrease in an amount of use of server resources and networks. However, since a current network environment of the Internet does not support the multicast transport, it is unavailable. Thus, a method of distributing a network load on a server through inter-PC re-transmission is currently used in place of the multicast transport.

Meanwhile, a movie reproduced through a streaming service does not suffer from illegal copy because it is not saved in the user PC, unlike a movie saved and reproduced on the user PC. However, with recent advent of programs capable of saving movies serviced by streaming, a technical action is taken for protecting a copyright for the movie serviced by streaming. However, a copyright of contents re-transmitted between PCs is not still protected.

### DISCLOSURE OF INVENTION

### Technical Problem

In the case of content service through re-transmission, since the content service is provided by ordinary individuals, as well as a content service provider, a copyright protection scheme needs to consider the ordinary users who perform the re-transmission.

Accordingly, there is a need for a key management method that allows intermediate re-senders to participate in issuing encryption/decryption keys to provide a certain reward to users responsible for re-transmission in order to resolve an issue of illegal copy of digital contents, unlike a traditional method that allows only a server to issue the encryption/decryption keys.

### Technical Solution

In accordance with one aspect of the invention, an apparatus for protecting contents streamed through re-transmission, includes a content service site for servicing a content, managing end user and re-sender re-transmitting the content streamed from the content service site to another user, and issuing and managing a re-transmission license and a content license. The end user pays a charge to the content service site, receives an issued license from the content service site, and uses the content received from the re-sender through re-transmission. The content service site includes a content streaming processor for servicing a content protected by encryption to re-sender through streaming, a license issue and management unit for issuing a license including a re-transmission encryption key and a content encryption key to the re-sender, issuing a license including a re-transmission encryption key of a user-selected re-transmission processor to the end user, and managing an issue specification, and a charge processor for performing billing for the content to the end user and paying a re-transmission charge to the re-sender. The content streaming processor includes a streaming data transformer for reading the content data to form a streaming packet according to a streaming protocol, an encryption processor for encrypting a portion of the streaming packet formed by the streaming data transformer, and a streaming data transmitter for transmitting the encrypted streaming packet to the re-sender. The license issue and management unit includes a content use license issue module for issuing a license for content reproduction in response to a request from the end user, a re-transmission license issue module for issuing a license for re-transmission to the re-sender, and a re-sender management module for authenticating and managing the re-sender. The re-sender includes a key packet generator for generating a key packet to be inserted into a content stream with a re-transmission encryption key, a stream re-transmission processor for transmitting a content received through streaming and a key packet generated by the key packet generator to the end user, a license manager for managing the re-transmission license received from the content service site and providing the re-transmission encryption key included in the license to the key packet generator, and a user manager for managing an end-user who receive the re-transmitted content. The re-sender includes a streaming data receiver for receiving a content stream from the content service site or through re-transmission, a streaming data generator for generating streaming data, the streaming data being obtained by inserting the key packet generated by the key packet generator into the content stream, and a streaming data transmitter for transmitting the streaming data generated by the streaming data generator to the end-user registered in the user manager. The user manager includes a charge settlement request module for reporting a re-transmission specification to the content service site and requesting a reward for the re-transmission, an access specification manager for periodically receiving log information for the access specification from the end user receiving the content through re-transmission, and storing and managing the log information, and a user registration module for storing and managing user information in response to a request from a user desiring to receive a re-transmitted content. The end user re-transmits the content streamed from the re-sender to another end user.

In accordance with another aspect of the invention, a method for protecting contents streamed through re-transmission, includes (a) selecting, by a user, a specific re-sender from a content service site, (b) accessing, by the user, the re-sender and receiving a re-sender ID from the content service site, (c) requesting, by the user, a license from the content service site using the re-sender ID, (d) issuing, by the content service site, the license to the user, and (e) receiving, by the user, a content re-transmitted from the re-sender and reproducing the content using the issued license. The step (a) includes (a1) retrieving, by the user, a re-sender list from the content service site, and (a2) selecting, by the user, one re-sender from the retrieved re-sender list for content re-transmission. The step (b) includes (b1) informing, by the content service site, the user of network address information so that the user accesses the selected re-sender, (b2) accessing, by the user, the re-sender using the network address information, and (b3) sending, by the re-sender, its own ID received from the content service site to the user.

### BRIEF DESCRIPTION OF THE DRAWINGS

The above and other objects and features of the present invention will become apparent from the following description of embodiments given in conjunction with the accompanying drawings, in which:

FIG. 1 is a diagram illustrating a content streaming service through re-transmission according to an embodiment of the present invention;

FIG. 2 is a flowchart illustrating a process of setting a user as a re-sender in a method for protecting contents according to the present invention;

FIGS. 3 and 4 are flowcharts illustrating a process in which an end user receives and views a content re-transmitted by a re-sender in a method for protecting contents according to the present invention;

FIG. 5 is a diagram illustrating a key issue method when a content is streamed via one re-sender in a method for protecting contents according to the present invention;

FIG. 6 is a diagram illustrating a key issue method when a content is streamed via two re-senders in a method for protecting contents according to the present invention;

FIG. 7 is a block diagram illustrating a content service site according to the present invention;

FIG. 8 is a block diagram illustrating a content streaming processor according to the present invention;

FIG. 9 is a block diagram illustrating a license issue and management unit according to the present invention;

FIG. 10 is a block diagram illustrating a re-transmission processor installed in a re-sender according to the present invention;

FIG. 11 is a block diagram illustrating a stream re-transmission processor according to the present invention;

FIG. 12 illustrates an embodiment of a streaming packet transmitted by a streaming data transmitter according to the present invention;

FIG. 13 is a block diagram illustrating a user manager according to the present invention;

FIG. 14 illustrates a structure of log information that an end user periodically reports to an access specification manager according to the present invention;

FIG. 15 illustrates an embodiment of information that a re-sender sends to a content service site for settlement request according to the present invention; and

FIG. 16 is a flowchart illustrating a process in which an end user consumes contents through re-transmission according to the present invention.

### BEST MODE FOR CARRYING OUT THE INVENTION

Hereinafter, embodiments of the present invention will be described in detail with reference to the accompanying drawings so that they can be readily implemented by those skilled in the art.

In the present invention, a technical device for protecting a copyright of a content serviced through re-transmission is provided such that a load on the server is distributed and a variety of content reception methods and purchase conditions are provided to users. Thus, the aforementioned object can be easily achieved.

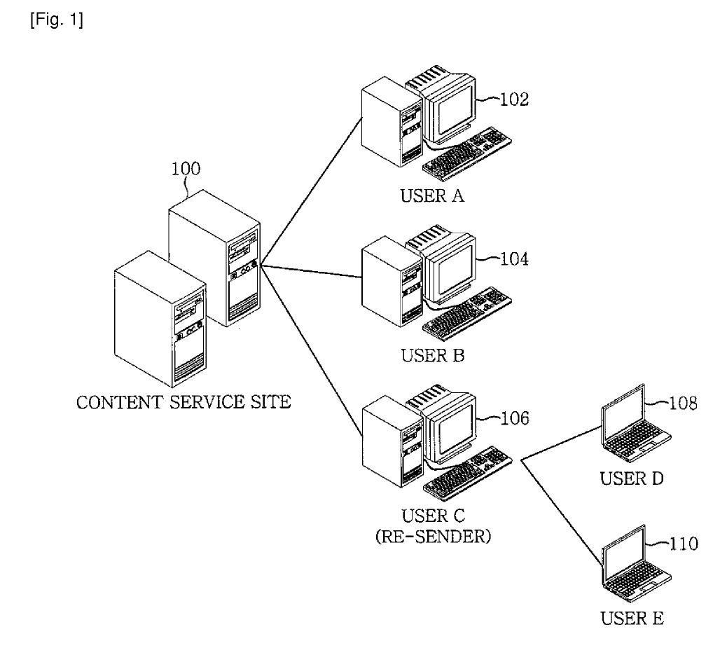

FIG. 1 is a diagram illustrating a content service system providing a content service according to an embodiment of the present invention.

Referring to FIG. 1, when a content service site 100 directly transmits a content to some users 102, 104, and 106 through streaming, the user 106 sends the streamed content to other users 108 and 110 through re-transmission.

That is, the users 108 and 110 receive the content from the intermediate re-sender instead of receiving it from the content service site 100. In this service environment, a method, in which the content service site 100 rewards the intermediate re-sender 106 for the re-transmission so that such users permit their PCs to be used for content re-transmission, is used.

Meanwhile, since the content service site 100 measures and uses a time when a related program is executed on the user PC to provide the reward for the content re-transmission, it cannot recognize possible falsification of the time that may be intentionally made by the user. Accordingly, in the present invention, the intermediate re-sender 106 receives a confirmation data for data transmission from end users 108 and 110, who have received the contents actually re-transmitted by the intermediate re-sender 106, and submits the confirmation data to the content service site 100 for verification of the re-transmission.

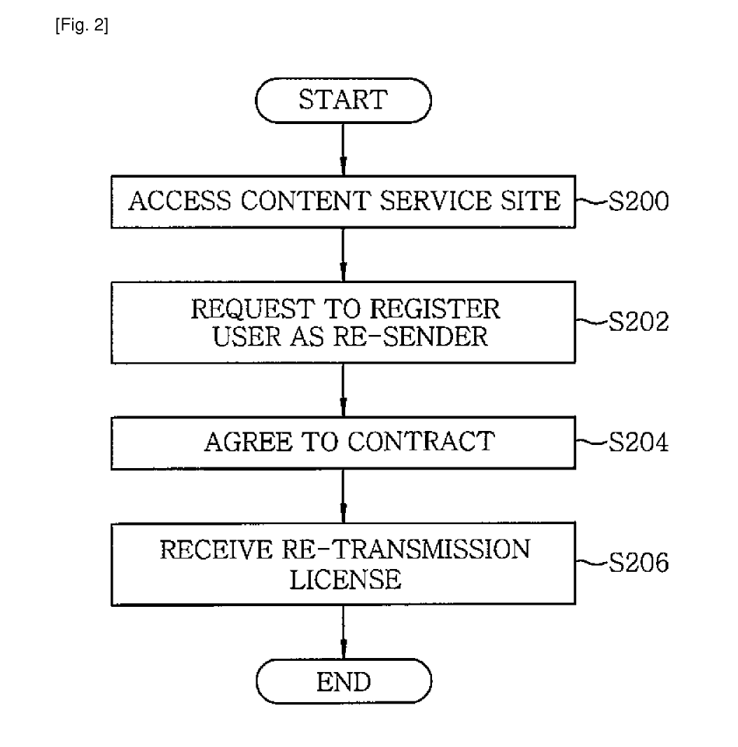

FIG. 2 is a flowchart illustrating a process of setting a user as a re-sender in a method for protecting contents upon streaming contents through re-transmission according to an embodiment of the present invention.

First, the user 106 desiring to perform streaming re-transmission accesses the content service site 100 (S200) and requests the content service site 100 to register the user 106 as a re-sender (S202).

The content service site 100 provides re-transmission contract information to the user 106. When the user 106 reads and satisfies the contract information contract information, he or she agrees to the contract (S204). If the user agrees to the contract, the content service site 100 issues a re-transmission license to the user 106 and adds the user 106 to a re-sender list (S206).

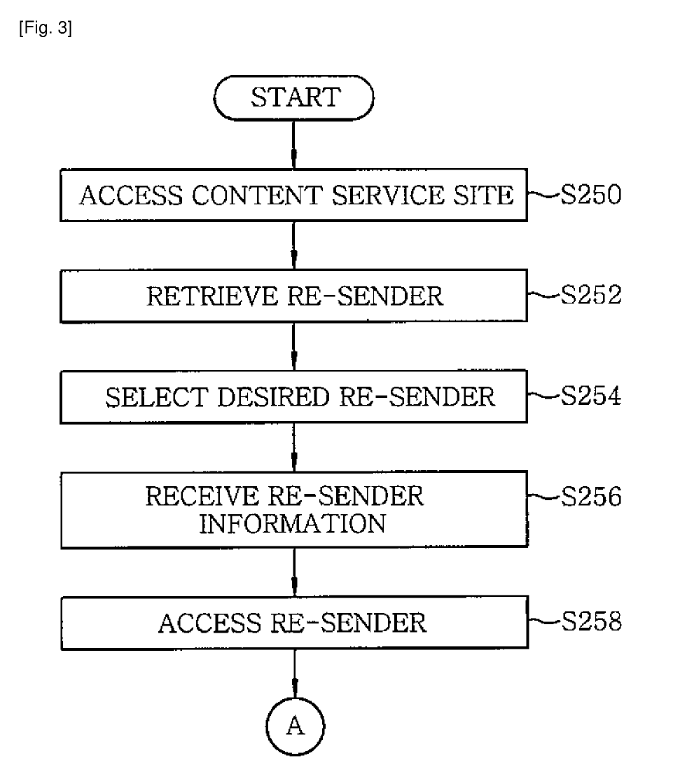

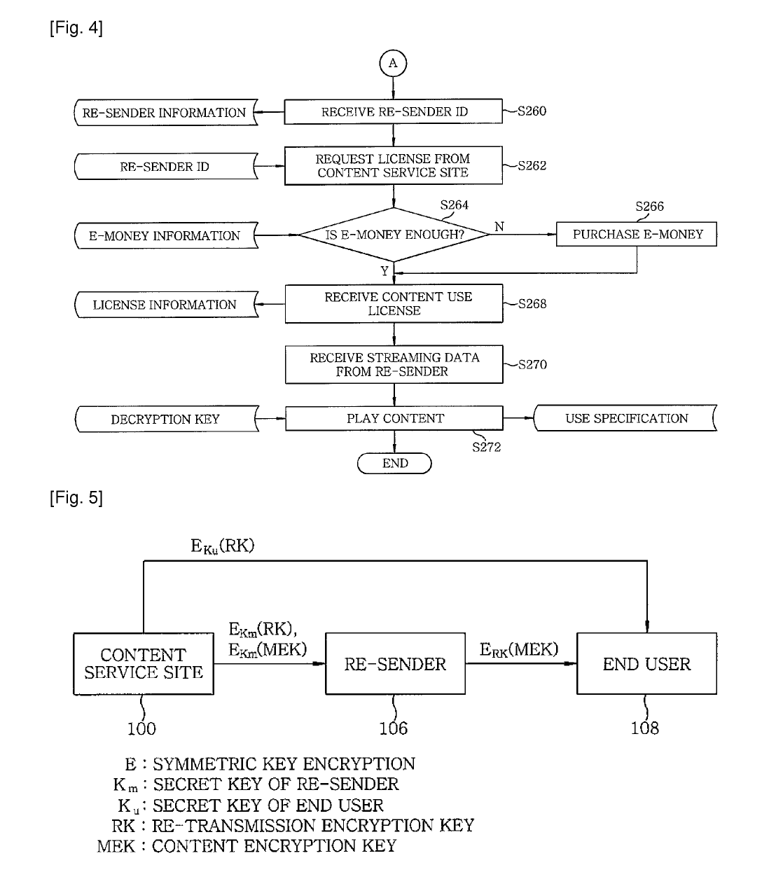

FIGS. 3 and 4 are flowcharts illustrating a process in which the end user 108 receives and views the content re-transmitted by the re-sender 106 in a method for protecting contents upon streaming contents through re-transmission according to an embodiment of the present invention.

First, user D 108 accesses the content service site 100 (S250) and then retrieves a re-sender list on the content service site 100 (S252).

User D 108 then selects the user C 106 as a re-transmission server by retrieving the re-sender list (S254). After the re-transmission server is selected, the content service site 100 informs user D 108 of network address information to access user C 106.

Upon receipt of the network address information of user C 106 from the content service site 100 (S256), the user D 108 accesses the re-sender, user C 106 using the received network address information of user D 106 (S258).

User C 106 then sends an ID received from the content server to user D 108 (S260). User D 108 requests the license from the content service site 100 using the ID received by user C 106 (S262).

The content service site 100 determines whether e-money of user D 108 requesting the license is enough (S264). If the e-money is enough, the content service site 100 issues a content use license (S268). If the e-money is not enough, user D 108 purchases e-money required to acquire the license for content use (S266).

When receiving the license issued from the content service site 100, user D 108 receives a content re-transmitted by the re-sender, user C 106 (S270), and views the content using the license issued by the content service site 100 (S272).

FIG. 5 is a diagram illustrating a key issue method when a content is streamed via one re-sender in a method for protecting contents according to an embodiment of the present invention.

Referring to FIG. 5, a content service site 100 encrypts a re-transmission encryption key, i.e., a relay key RK, and a key for encrypting a content, i.e., a media encryption key (MEK), with a secret key Km of a re-sender 106, and sends the encrypted key to the re-sender 106. The content service site 100 encrypts a re-transmission encryption key RK of the re-sender 106 selected as a re-sender by a user with a secret key Ku of an end user 108, and sends the encrypted key to the end user 108.

The content service site 100 transmits the content to the re-sender 106 through streaming. In this case, the content is encrypted with the content encryption key MEK. The re-sender 106 just re-transmits the data, which is received through streaming, to the end user 108. In this case, the re-sender 106 periodically inserts a E_{RK}(MEK) value obtained by encrypting the content encryption key MEK with its re-transmission encryption key RK, between streaming packets. When receiving the key packet where the E_{RK}(MEK) value is inserted, the end user 108 decrypts the key packet with the re-transmission encryption key RK received from the content service site 100 to extract the content encryption key MEK. The end user 108 decrypts and reproduces the streaming content with the extracted MEK.

Meanwhile, the re-transmission action in the present invention may be expanded to two or more steps. That is, re-transmitted streaming data may be further sent to another user through the re-transmission.

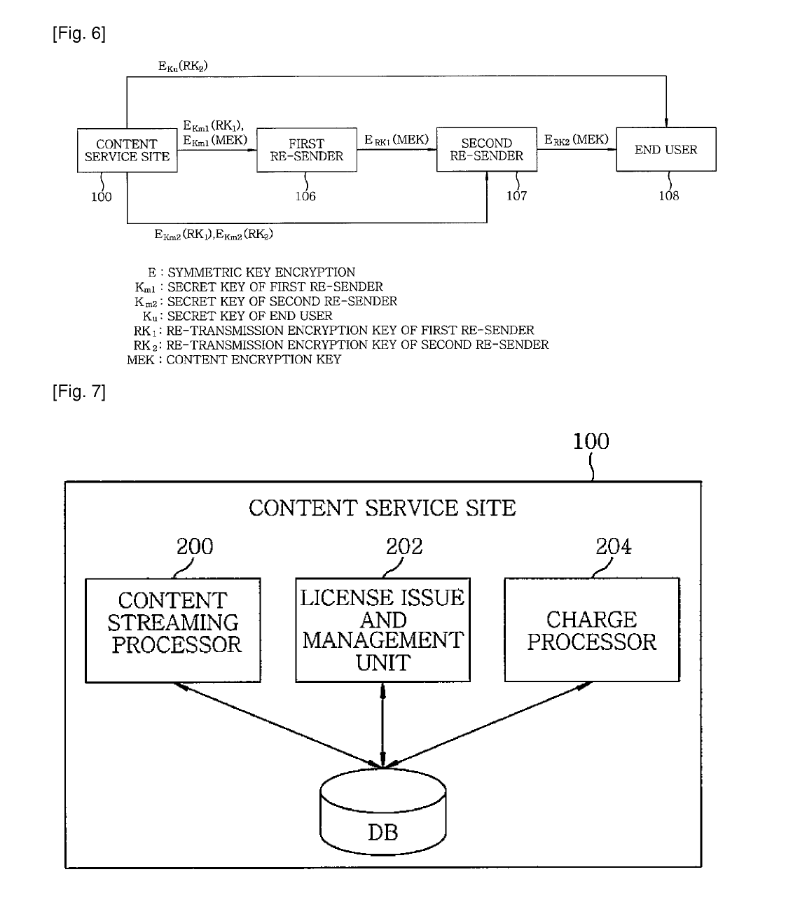

FIG. 6 is a diagram illustrating a key issue method when two re-transmissions occur according to an embodiment of the present invention. It will be appreciated by those skilled in the art that three re-transmissions may occur. For ease of illustration, the case that two re-transmissions occur is explained.

When a second re-sender 107 selected by an end user 108 is another re-sender, key issue is made as follows: A content service site 100 encrypts a re-transmission encryption key RK₁ and a media encryption key MEK, which is a key for encrypting a content, with a secret key Kₘ₁ of a first re-sender 106, and sends the encrypted key to a first re-sender 106.

The content service site 100 encrypts a re-transmission encryption key RK₂ and a re-transmission encryption key RK₁ of the first re-sender 106, from which the second re-sender 107 receives the content, with a secret key Kₘ₂ of the second re-sender 107, and sends the encrypted key to the second re-sender 107. The content service site 100 encrypts a re-transmission encryption key RK₂ of the second re-sender 107 selected as a re-sender by the user with a secret key Ku of the end user 108, and sends the encrypted key to the end user 108.

The content service site 100 then transmits the content to the first re-sender 106 through streaming. In this case, the content is encrypted by the content encryption key MEK. The first re-sender 106 just re-transmits the data received through streaming, to the second re-sender 107. In this case, the first re-sender 106 periodically inserts a value E_{RK1} (MEK) obtained by encrypting the content encryption key MEK with its own re-transmission encryption key RK₁, between streaming packets.

The second re-sender 107, when receiving a key packet including the Eₘᵤ (MEK) value, extracts the MEK with the re-transmission encryption key RK₁ received from the content service site 100. The second re-sender 107 encrypts the extracted MEK with its own re-transmission encryption key RK₂ and generates E_{RK2} (MEK). This value is used in place of the E_{RK1} (MEK) value included in the key packet sent by the first re-sender 106. That is, the streaming data to be re-transmitted by the second re-sender 107 includes a key packet newly inserted by the second re-sender 107, with the key packet of the first re-sender 106 deleted.

The end user 108, when receiving the key packet with the E_{RK2} (MEK) value, decrypts the key packet with the re-transmission encryption key RK₂ received from the content service site 100 to extract the content encryption key MEK. The end user 108 decrypts and reproduces the streaming content by using the extracted MEK.

FIG. 7 is a block diagram illustrating a content service site 100 according to an embodiment of the present invention. The content service site 100 includes a content streaming processor 200, a license issue and management unit 202, and a charge processor 204.

Referring to FIG. 7, the content streaming processor 200 provides contents to users through streaming. The streaming data is protected by encryption. The license issue and management unit 202 issues a license including encryption/decryption keys needed for re-transmission and content reproduction to all users including the re-sender, and manages issue specification. The charge processor 204 performs billing for contents and pays a re-transmission charge to the re-senders.

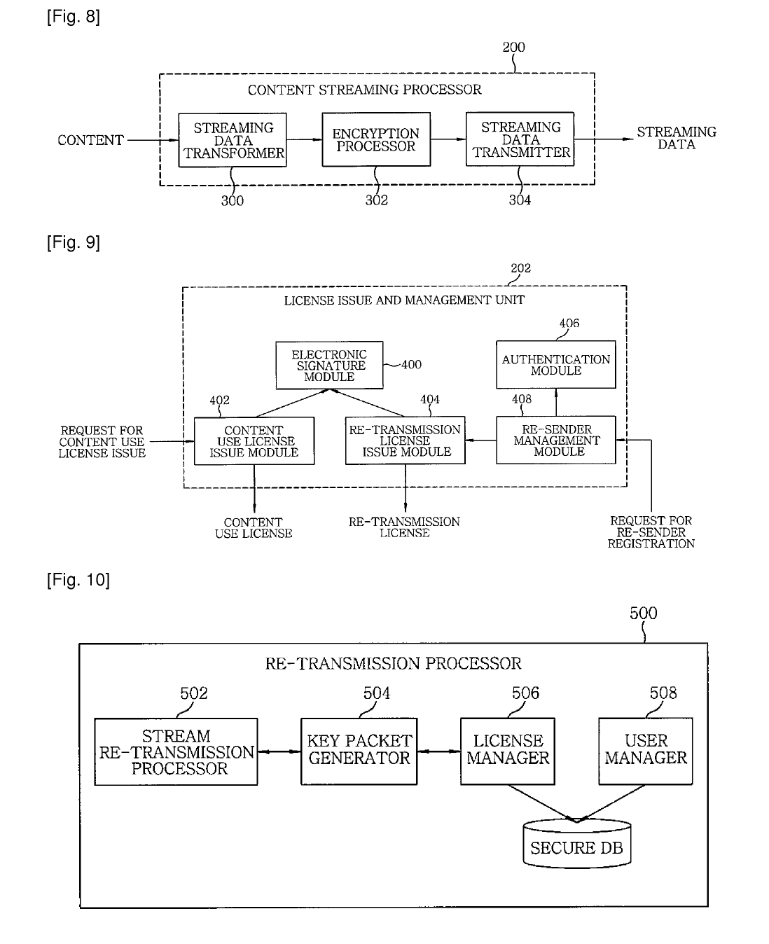

FIG. 8 is a block diagram illustrating the content streaming processor 200 of FIG. 7. The content streaming processor 200 includes a streaming data transformer 300, an encryption processor 302, and a streaming data transmitter 304.

Referring to FIG. 8, the streaming data transformer 300 reads data from a content file and forms a streaming packet according to a streaming protocol. The encryption processor 302 encrypts a pay portion corresponding to a payload of streaming packet formed in the streaming data transformer 300, using a symmetric key algorithm. Here, the encrypted data cannot be decrypted by a user having no decryption key, making it possible to protect contents from unauthorized users. The streaming data transmitter 304 transmits the streaming packet encrypted in the encryption processor 302 to a network.

FIG. 9 is a block diagram illustrating the license issue and management unit 202 in FIG. 7. The license issue and management unit 202 includes a content use license issue module 402, a re-transmission license issue module 404, a re-sender management module 408, an electronic signature module 400, and an authentication module 406.

Referring to FIG. 9, the content use license issue module 402 issues a license for content reproduction in response to a request from an end user. When the end user desires to receive a content through re-transmission, re-sender s re-transmission encryption key RK selected by the end user is contained in the license.

The re-transmission license issue module 404 issues a license for re-transmission to a user desiring to re-transmission. The re-transmission license includes the re-transmission encryption key RK of the re-sender. The re-sender management module 408 authenticates the requested re-sender and permits a role as the re-sender, and manages the re-senders. The electronic signature module 400 and the authentication module 406 are software libraries for performing electronic signature and authentication in information protection.

FIG. 10 is a block diagram illustrating a re-transmission processor 500 installed in the re-sender according to an embodiment of the present invention. The re-transmission processor 500 includes a stream re-transmission processor 502, a key packet generator 504, a license manager 506, and a user manager 508.

Referring to FIG. 10, the stream re-transmission processor 502 just sends the content received through streaming, to a next user. The key packet generator 504 generates a key packet to be inserted into the content stream by using the re-transmission encryption key.

The license manager 506 manages the re-transmission license received from the content service site and provides the re-transmission encryption key included in the license to the key packet generator 504. The user manager 508 manages users who receive contents re-transmitted from the re-sender. The stream re-transmission processor 502 re-transmits the content stream to the users registered in the user manager 508.

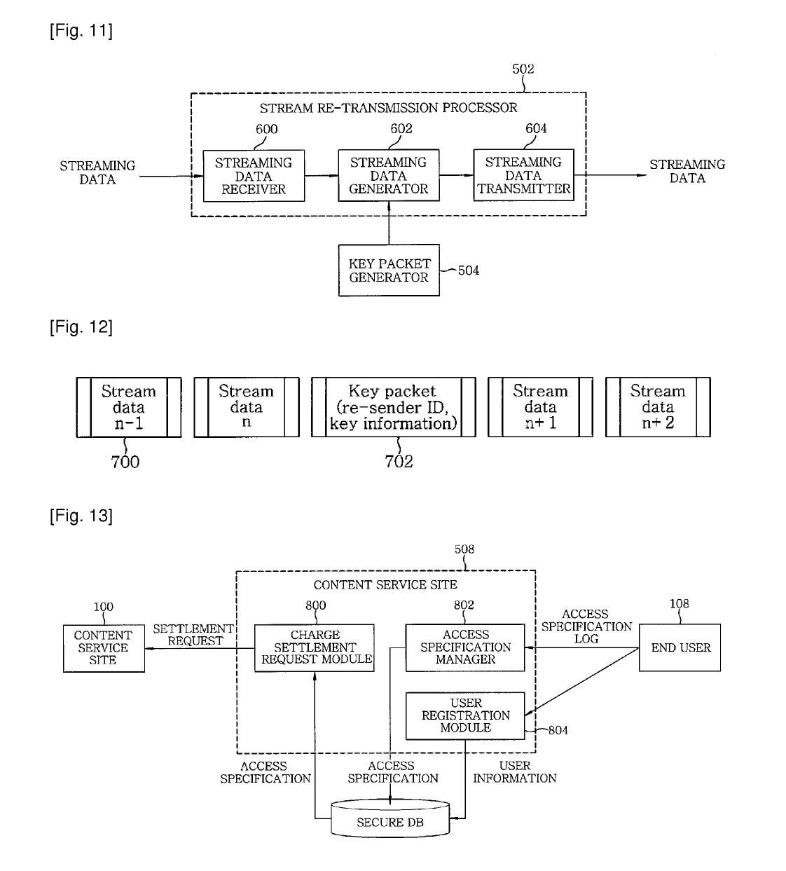

FIG. 11 is a block diagram illustrating the stream re-transmission processor 502 in FIG. 10. The stream re-transmission processor 502 includes a streaming data receiver 600, a streaming data generator 602, and a streaming data transmitter 604.

Referring to FIG. 11, the streaming data receiver 600 receives a content stream from a content service site or a previous re-sender. The streaming data generator 602 generates streaming data by inserting the key packet generated in the key packet generator 504 into the received streaming data. The streaming data transmitter 604 transmits the streaming data generated by the streaming data generator 602 to the users registered in the user manager 508.

FIG. 12 illustrates an embodiment of a streaming packet transmitted by the streaming data transmitter 604 in FIG. 11.

Referring to FIG. 12, a network packet including stream data 700 is content streaming data transmitted from the content service site 100. The key packet 702 is inserted by the re-sender, and includes a re-sender ID assigned by the content service site 100 and key information needed for decrypting the encrypted content stream. In this case, a period in which the key packet 702 is inserted may be determined according to a policy of the content service site 100. For example, the key packet 702 may be inserted every 10 seconds, or may be inserted directly before the streaming packet including the key frame.

FIG. 13 is a block diagram illustrating the user manager 508 in FIG. 10. The user manager 508 includes a charge settlement request module 800, an access specification manager 802, and a user registration module 804.

Referring to FIG. 13, the charge settlement request module 800 reports a re-transmission specification to the content service site 100, and requests a reward for the re-transmission. The access specification manager 802 periodically receives an access log from the end user 108 who receives the content through re-transmission, and stores and manages the access log. The user registration module 804 receives a request of a user desiring to receive a re-transmitted content, and stores and manages the user information.

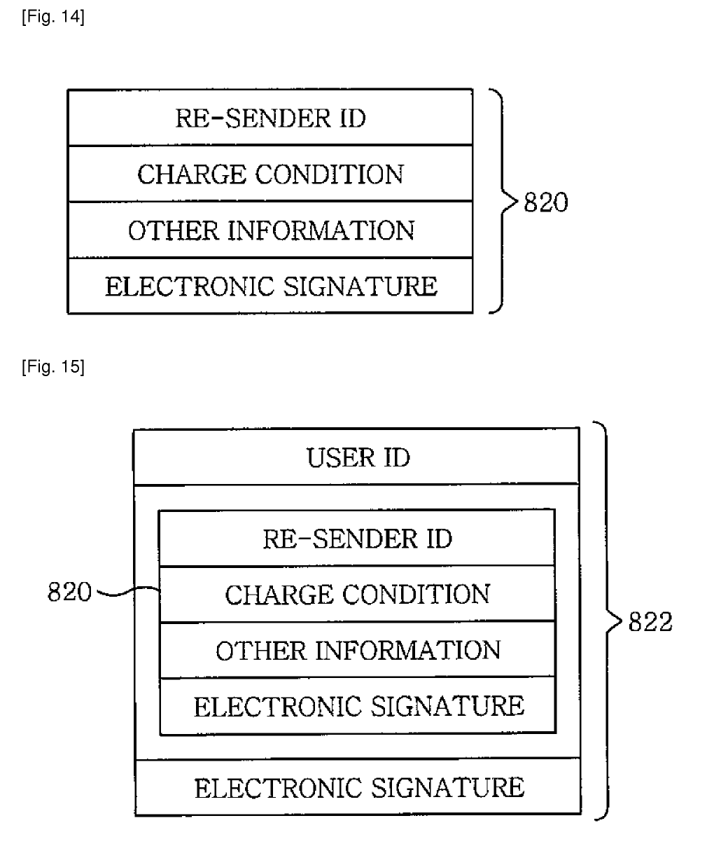

FIG. 14 shows a content included in the log information 820 that the end user 108 periodically reports to the access specification manager 802 according to an embodiment of the present invention.

Referring to FIG. 14, the log information 820 includes a re-sender ID, re-sender information, charge condition, other information, and electronic signature. Among the information, information to be reported by the other information is determined by the content service site. The electronic signature prevents the re-sender from falsifying the log specification. The end user sends the log to the re-sender in a period determined by the content service site.

FIG. 15 illustrates an embodiment of information that the re-sender sends to the content service site for settlement request according to an embodiment of the present invention. Information 822 that the re-sender sends to the content service site for settlement request is generated by adding a user ID and an electronic signature of the re-sender to the log information 820 shown in FIG. 14.

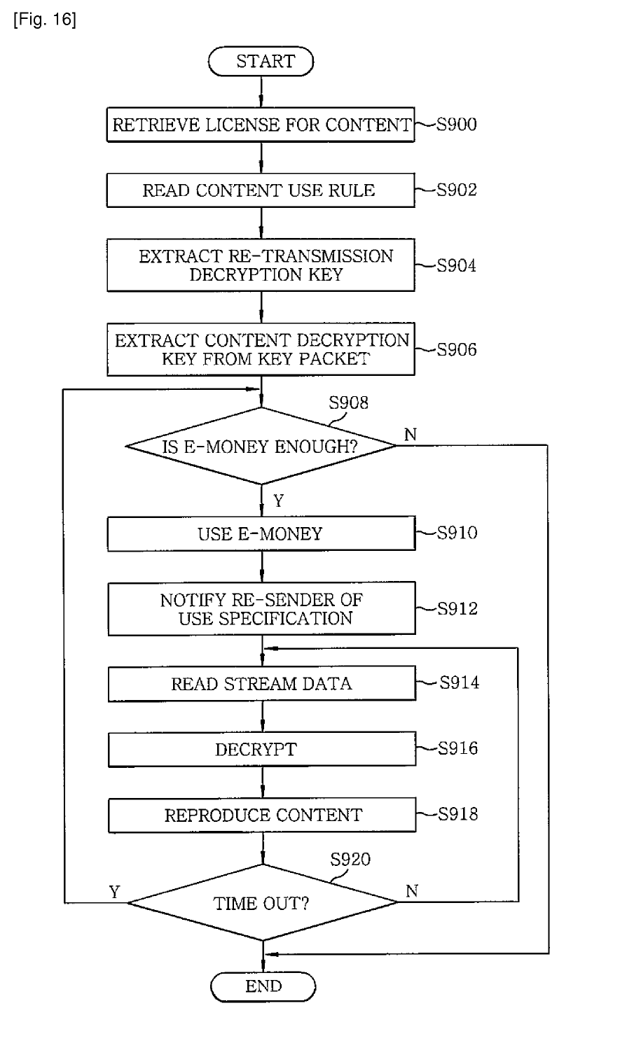

FIG. 16 is a flowchart illustrating a process in which an end user consumes a content through re-transmission according to an embodiment of the present invention.

First, the end user 108 retrieves a license for a content desired for viewing (S900). In this case, when there is the license, the end user 108 reads a content use rule on the license (S902).

When a content use right exists as a result of confirming the content use rule, the end user 108 extracts a re-transmission decryption key from the license (S904), and extracts a content decryption key from a key packet included in the received content stream with the re-transmission decryption key (S906).

The end user 108 then determines whether e-money is enough to reproduce the content (S908). If the e-money is not enough, the end user 108 stops reproduction. However, if the charge is enough, the content charge is subtracted from the e-money (S910), and the end user 108 notifies the re-sender 106 of a content use specification (S912).

The end user 108 then receives the content stream data from the re-sender 106 (S914). The end user 108 then decrypts the content stream received from the re-sender 106 with the content decryption key (S916), and reproduces the decrypted content stream (S918).

The end user 108 determines whether a time corresponding to the paid charge elapses, while reproducing the content stream (S920). If the time corresponding to the paid charge elapses, the end user 108 re-pays the charge and repeatedly performs processes S908 to S918.

The method of the present invention as described above may be implemented by a program, which may be stored in a computer-readable form in a recording medium (e.g., a compact disk-read only memory (CD-ROM), a random access memory (RAM), a read-only memory (ROM), a floppy disc, a hard disc, a magneto-optical disc, etc.). A further description of this process will not be provided because the process may be easily carried out by those skilled in the art.

According to the present invention, a technical device for protecting a copyright for contents serviced through re-transmission is provided, such that a load on the server is distributed for a content service provider, a reward for re-transmission is provided to re-senders, and final content users select a desired condition from several content reception methods and content purchase conditions. This is profitable for all the participants providing and consuming contents.

While the invention has been shown and described with respect to the embodiments, it will be understood by those skilled in the art that various changes and modifications may be made without departing from scope of the invention as defined in the following claims.

1. An apparatus for protecting contents streamed through re-transmission, the apparatus comprising:
a content service site for servicing a content, managing end user and re-sender which re-transmits the content streamed from the content service site to another user, and issuing and managing a re-transmission license and a content license, wherein the end user pays a charge to the content service site, receives an issued license from the content service site, and uses the content received from the re-sender through re-transmission.

2. The apparatus of claim 1, wherein the content service site comprises:
a content streaming processor for servicing a content protected by encryption to re-sender through streaming;
a license issue and management unit for issuing a license including a re-transmission encryption key and a content encryption key to the re-sender, issuing a license including a re-transmission encryption key of a user-selected re-transmission processor to the end user, and managing an issue specification; and
a charge processor for performing billing for the content to the end user and paying a re-transmission charge to the re-sender.

3. The apparatus of claim 2, wherein the content streaming processor comprises:
a streaming data transformer for reading the content data to form a streaming packet according to a streaming protocol;
an encryption processor for encrypting a portion of the streaming packet formed by the streaming data transformer; and
a streaming data transmitter for transmitting the encrypted streaming packet to the re-sender.

4. The apparatus of claim 2, wherein the license issue and management unit comprises:
a content use license issue module for issuing a license for content reproduction in response to a request from the end user;
a re-transmission license issue module for issuing a license for re-transmission to the re-sender; and
a re-sender management module for authenticating and managing the re-sender.

5. The apparatus of claim 1, wherein the re-sender comprises:
a key packet generator for generating a key packet to be inserted into a content stream with a re-transmission encryption key;
a stream re-transmission processor for transmitting a content received through streaming and a key packet generated by the key packet generator to the end user;
a license manager for managing the re-transmission license received from the content service site and providing the re-transmission encryption key included in the license to the key packet generator; and
a user manager for managing an end-user who receive the re-transmitted content.

6. The apparatus of claim 5, wherein the re-sender comprises:
a streaming data receiver for receiving a content stream from the content service site or through re-transmission;
a streaming data generator for generating streaming data, the streaming data being obtained by inserting the key packet generated by the key packet generator into the content stream; and
a streaming data transmitter for transmitting the streaming data generated by the streaming data generator to the end-user registered in the user manager.

7. The apparatus of claim 5, wherein the user manager comprises:
a charge settlement request module for reporting a re-transmission specification to the content service site and requesting a reward for the re-transmission;
an access specification manager for periodically receiving log information for the access specification from the end user receiving the content through re-transmission, and storing and managing the log information; and
a user registration module for storing and managing user information in response to a request from a user desiring to receive a re-transmitted content.

8. The apparatus of claim 1, wherein the end user re-transmits the content streamed from the re-sender to another end user.

9. A method for protecting contents streamed through re-transmission, the method comprises:
selecting, by a user, a specific re-sender from a content service site;
accessing, by the user, the re-sender and receiving a re-sender ID from the content service site;
requesting, by the user, a license from the content service site using the re-sender ID;
issuing, by the content service site, the license to the user; and
receiving, by the user, a content re-transmitted from the re-sender and re-producing the content using the issued license.

10. The method of claim 9, wherein the selecting the specific re-sender comprises:
retrieving, by the user, a re-sender list from the content service site; and
selecting, by the user, one re-sender from the retrieved re-sender list for content re-transmission.

11. The method of claim 9, wherein the accessing the re-sender and the receiving the re-sender ID comprises:
informing, by the content service site, the user of network address information so that the user accesses the selected re-sender;
accessing, by the user, the re-sender using the network address information; and
sending, by the re-sender, its own ID received from the content service site to the user.
